(19) United States
(12) Patent Application Publication
(10) Pub. No.: US 2024/0261969 A1
(43) Pub. Date: Aug. 8, 2024

(54) OPTIMIZATION ASSISTANCE DEVICE

(71) Applicant: FANUC CORPORATION, Minamitsuru-gun, Yamanashi (JP)

(72) Inventors: Daiki YAMAGUCHI, Yamanashi (JP); Tatsuya OUMI, Yamanachi (JP)

(21) Appl. No.: 18/565,195

(22) PCT Filed: Jul. 2, 2021
(86) PCT No.: PCT/JP2021/025158

§ 371 Date: Nov. 29, 2023

(51) Int. Cl. B25J 9/16; B25J 13/08

(52) U.S. Cl. CPC B25J 9/1671; B25J 9/1664; B25J 13/089

(57) ABSTRACT

An optimization assistance device comprises: a position data acquisition unit for acquiring a plurality of items of position data pertaining to coordinate values of an orthogonal coordinate system from a movement program of a robot; an orientation provisional designation unit for provisionally designating, for each of the plurality of items of position data, a plurality of shapes that can be attained by the robot, and excluding shapes that cannot be attained by the robot; a movement program generation unit for combining the remaining shapes for each of the plurality of items of position data and generating a plurality of movement programs; and a movement program selection unit for simulating each of the plurality of movement programs, calculating evaluation index values, and selecting the movement program having the lowest evaluation index value as an optimal movement program.

### TECHNICAL FIELD

The present invention relates to an optimization assistance device.

### BACKGROUND ART

When creating a robot motion program, orthogonal coordinate values or axis values are used as position data. Axis values designate the values of each axis of the robot. On the other hand, orthogonal coordinate values designate the coordinate values (x, y, z) from the origin of the orthogonal coordinates in space to the origin of the orthogonal coordinate system on the tool side, and also designate the rotation angles w, p, r of the tool coordinate system around the X, Y, and Z axes of the orthogonal coordinate system. However, there are several forms (postures of the robot body) that satisfy the conditions of the orthogonal coordinate values (x, y, z, w, p, r) of the robot. Therefore, since the orthogonal coordinate values (x, y, z, w, p, r) alone cannot instruct a single posture, it is necessary to designate the axis configuration and the rotation number of each axis to determine the form, which takes effort.

Some robot motion programs created using the orthogonal coordinate system can execute the motion program and move the robot to a predetermined position; however, since the form is not taken into consideration, a motion program that leaves room for improvement may be generated.

In this regard, a technique has been known, which performs a motion simulation for all combinations of a plurality of candidates for the end-effector postures of the operator and the robot in each position data where the positions and postures of the operator and the robot are designated, calculates the required time for production work by the cooperation of the operator and the robot, and determines the combination of the position of the operator and the position of the robot with the shortest required time, thereby shortening the startup time of the production system by the cooperative work of the operator and the robot. For example, see Patent Document 1.

### CITATION LIST

### Patent Document

Patent Document 1: Japanese Unexamined Patent Application, Publication No. 2010-211726

### DISCLOSURE OF THE INVENTION

### Problems to be Solved by the Invention

Patent Document 1 performs a motion simulation so as to cover all combinations of a plurality of candidates for end-effector postures in each position data; however, the candidates for end-effector postures include end-effector postures that cannot be attained by the robot. Therefore, the motion simulation in Patent Document 1 includes unworkable candidates for end-effector postures, which is a problem. It has been desired to optimize a motion program by selecting appropriate candidates for end-effector postures and combining them to perform a motion simulation for a motion program that has already been created and can be executed to the end without changing the arrangement or position coordinates of the robot.

Therefore, when executing the motion simulation, it has been desired to easily set the candidates for forms that can be attained by the robot for each designated position data, without changing the arrangement or position coordinates of the robot for a motion program that has already been created and can be executed to the end, and to optimize the motion program by performing a motion simulation.

### Means for Solving the Problems

One aspect of the optimization assistance device of the present disclosure is an optimization assistance device that optimizes a motion program of a robot by considering a form of the robot, in which the device includes: a position data acquisition unit configured to acquire a plurality of position data of coordinate values in an orthogonal coordinate system taught along a motion path of the robot used in the motion program of the robot; a posture tentative designation unit configured to tentatively designate a plurality of forms that can be taken by the robot for each of the plurality of position data, and exclude a form that cannot be attained by the robot, from among the plurality of forms tentatively designated; a motion program generation unit configured to generate a plurality of motion programs by combining remaining ones of the forms in each of the plurality of position data; and a motion program selection unit configured to simulate each of the plurality of motion programs generated, calculate evaluation index values, and select a motion program with the smallest evaluation index value calculated, as an optimal motion program.

### Effects of the Invention

According to one embodiment, when executing the motion simulation, it is possible to easily set the candidates for forms that can be attained by the robot for each designated position data, without changing the arrangement or position coordinates of the robot for a motion program that has already been created and can be executed to the end, and to optimize the motion program by performing a motion simulation.

### BRIEF DESCRIPTION OF THE DRAWINGS

FIG. 1 is a functional block diagram illustrating a functional configuration example of a robot system according to one embodiment;

FIG. 2 is a diagram illustrating an example of a schematized robot;

FIG. 3 is a functional block diagram illustrating a functional configuration example of an optimization assistance device;

FIG. 4 is a diagram illustrating an example of a motion program;

FIG. 5 is a diagram illustrating an example of candidates for position data with different joint axis configurations for one position data;

FIG. 6A is a diagram illustrating an example of different robot forms with the same orthogonal coordinate values;

FIG. 6B is a diagram illustrating an example of different robot forms with the same orthogonal coordinate values;

FIG. 7 is a diagram illustrating an example of deleting position data;

FIG. 8A is a diagram illustrating an example of a singularity in the robot form;

FIG. 8B is a diagram illustrating an example of a singularity in the robot form;

FIG. 9 is a diagram illustrating an example of combinations of position data;

FIG. 10 is a diagram illustrating an example of a motion program before and after updating; and

FIG. 11 is a flowchart illustrating optimization processing by the optimization assistance device.

### PREFERRED MODE FOR CARRYING OUT THE INVENTION

Hereinafter, an embodiment will be described using drawings.

### One Embodiment

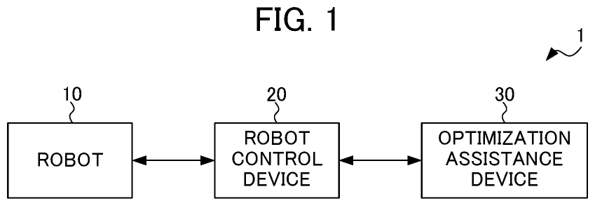

FIG. 1 is a functional block diagram illustrating a functional configuration example of a robot system according to one embodiment.

As illustrated in FIG. 1, a robot system 1 includes a robot 10, a robot control device 20, and an optimization assistance device 30.

The robot 10, the robot control device 20, and the optimization assistance device 30 may be directly connected to each other via a connection interface (not illustrated). The robot 10, the robot control device 20, and the optimization assistance device 30 may be interconnected via a network such as LAN (local area network). In this case, the robot 10, the robot control device 20, and the optimization assistance device 30 may be provided with a communication unit (not illustrated) for communicating with each other via such a connection.

The optimization assistance device 30 may be included in the robot control device 20, as will be described later.

### <Robot Control Device 20>

The robot control device 20 is a device for controlling a motion of the robot 10, and is known to those skilled in the art. For example, the robot control device 20 outputs a motion program, which is generated based on each orthogonal coordinate value (x, y, z, w, p, r) of the endpoint of the robot 10 in the world coordinate system (described later) taught by the user operating a teaching operation panel (not illustrated) included in the robot control device 20, to the optimization assistance device 30 (described later). Then, the robot control device 20 acquires an optimized motion program from the optimization assistance device 30. The robot control device 20 generates control signals by executing the optimized motion program and outputs the generated control signals to the robot 10 to operate the robot 10.

### <Robot 10>

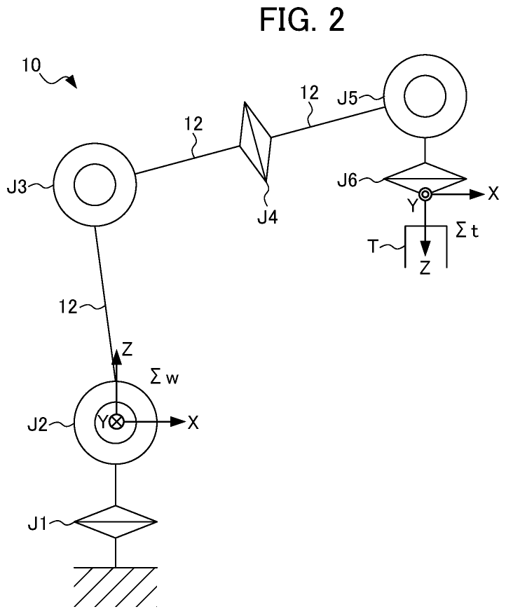

FIG. 2 is a diagram illustrating an example of a schematized robot 10.

For example, as illustrated in FIG. 2, the robot 10 is a six-axis vertical multi-joint robot, and has six joints J1 to J6 and an arm unit 12 that connects each of the joints J1 to J6. The robot 10 drives movable members such as the arm unit 12 by driving servo motors (not illustrated) arranged in each of the joints J1 to J6, based on the control signal from the robot control device 20. An end effector T such as a gripping hand is attached to the tip of the movable member of the robot 10, such as the tip of the joint J6.

As illustrated in FIG. 2, the robot 10 has a world coordinate system Σw as a three-dimensional orthogonal coordinate system that is fixed in space, and a tool coordinate system Σt as three-dimensional orthogonal coordinates that are set at the flange of the tip of the joint J6 of the robot 10. The robot control device 20 can control the position of the tip of the robot 10, where the end effector T is attached, using the position (orthogonal coordinate values) defined in the world coordinate system Σw.

Although the robot 10 is described as a six-axis vertical multi-joint robot, the robot 10 may be a vertical multi-joint robot having a different number of axes other than six, a horizontal multi-joint robot, a parallel link robot, or the like.

### <Optimization Assistance Device 30>

The optimization assistance device 30 is a computer device known to those skilled in the art.

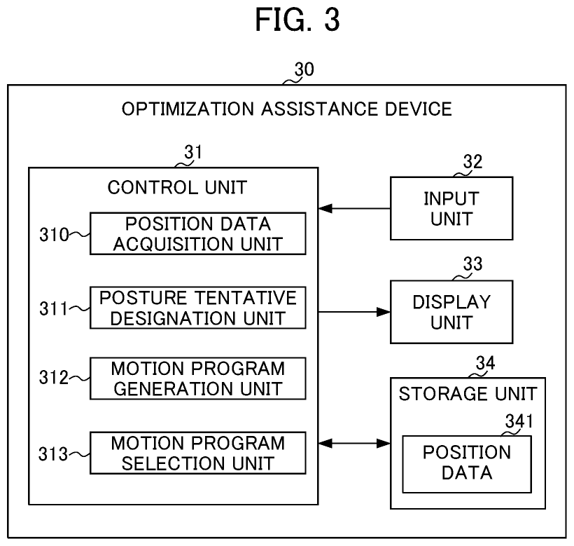

FIG. 3 is a functional block diagram illustrating a functional configuration example of the optimization assistance device 30.

As illustrated in FIG. 3, the optimization assistance device 30 includes a control unit 31, an input unit 32, a display unit 33, and a storage unit 34. The control unit 31 includes a position data acquisition unit 310, a posture tentative designation unit 311, a motion program generation unit 312, and a motion program selection unit 313.

### <Input Unit 32>

The input unit 32 is, for example, a keyboard or a touch panel arranged on the display unit 33 described later, and receives from the user the designation of evaluation index values (such as cycle time or power consumption) that the user wishes to optimize when optimizing the motion program of the robot 10.

### <Display Unit 33>

The display unit 33 is, for example, a liquid crystal display, and displays a motion program and position data acquired by the position data acquisition unit 310 (described later), a form (posture) of the robot (not illustrated) tentatively designated by the posture tentative designation unit 311 (described later), and a motion program selected by the motion program selection unit 313 (described later), etc.

### <Storage Unit 34>

The storage unit 34 is a ROM (Read Only Memory) or an HDD (Hard Disk Drive), and may store position data 341 along with various control programs.

The position data 341 stores the orthogonal coordinate values (x, y, z, w, p, r) of the position of the endpoint of the robot 10 in the world coordinate system Σw set in the motion program acquired by the position data acquisition unit 310 (described later), as position data.

### <Control Unit 31>

The control unit 31 includes a CPU (central processing unit), ROM, RAM (random access memory), CMOS (complementary metal-oxide-semiconductor) memory, etc., all of which are configured to be communicable with each other via a bus, and are known to those skilled in the art.

The CPU is a processor that totally controls the optimization assistance device 30. The CPU reads system programs and application programs stored in the ROM via the bus, and controls the entire optimization assistance device 30 in accordance with the system programs and the application programs. Thus, as illustrated in FIG. 3, the control unit 31 is configured to implement the functions of the position data acquisition unit 310, the posture tentative designation unit 311, the motion program generation unit 312, and the motion program selection unit 313. Various data such as temporary calculation data and display data are stored in RAM. The CMOS memory is backed up by a battery (not illustrated) and is configured as a non-volatile memory that maintains its storage state even when the power of the optimization assistance device 30 is turned off.

### <Position Data Acquisition Unit 310>

The position data acquisition unit 310, for example, acquires a plurality of position data of the coordinate values in the orthogonal coordinate system (world coordinate system Σw) taught along the motion path of the robot 10 used in the motion program of the robot 10.

Specifically, the position data acquisition unit 310, for example, acquires a motion program that has already been created and can be executed to the end from the robot control device 20, and acquires a plurality of position data, which are the coordinate values (x, y, z, w, p, r) in the world coordinate system Σw used in the acquired motion program.

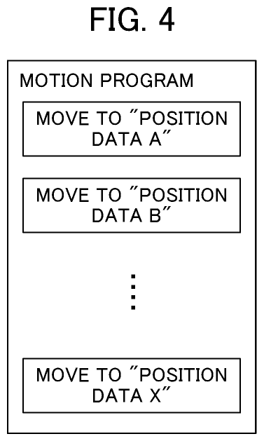

FIG. 4 is a diagram illustrating an example of a motion program.

As illustrated in FIG. 4, the motion program includes coordinate values (x, y, z, w, p, r) in the world coordinate system Σw taught along the motion path of the robot 10, such as “position data A”, “position data B”, “position data X”, etc. The position data acquisition unit 310 extracts and acquires “position data A”, “position data B”, “position data X”, etc. from the motion program in FIG. 4. The position data acquisition unit 310 may store the plurality of acquired position data in the position data 341.

The position data acquisition unit 310 may directly acquire a plurality of position data, which are the coordinate values (x, y, z, w, p, r) in the world coordinate system Σw, from the robot control device 20.

### <Posture Tentative Designation Unit 311>

The posture tentative designation unit 311 tentatively designates a plurality of postures that the robot 10 can take for each of the plurality of position data acquired by the position data acquisition unit 310, and excludes postures that cannot be attained by the robot 10 from the plurality of tentatively designated postures.

Specifically, the posture tentative designation unit 311 calculates the forms (postures) (displacements of the joints J1 to J6) of the robot 10 when moving the endpoint (end effector T) of the robot 10 to the coordinate values (x, y, z, w, p, r) in the world coordinate system Σw of “position data A”, “position data B”, “position data X”, etc., acquired by the position data acquisition unit 310, from known inverse kinematics calculations.

However, there are countless forms (displacements of the joints J1 to J6) of the robot 10 where the endpoint (end effector T) of the robot 10 becomes the coordinate values (x, y, z, w, p, r) obtained by the inverse kinematics calculations. For example, it is known that there are eight combination candidates of “up and down of the wrist”, “up and down of the arm”, and “front and back of the arm” for each of “position data A”, “position data B”, “position data X”, etc., just with the axis configurations of the joints J5, J3, and J1.

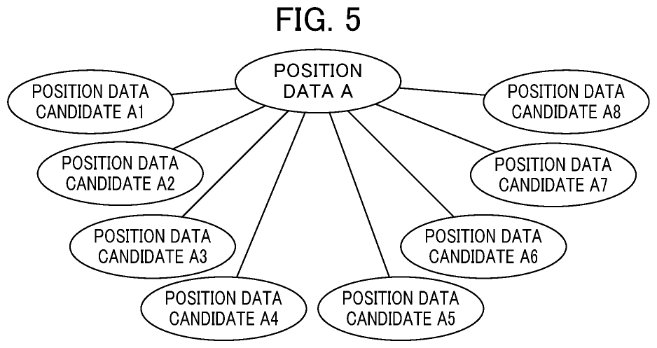

FIG. 5 is a diagram illustrating an example of position data candidates A1 to A8 with different axis configurations of the joints J5, J3, J1 for one position data.

The position data candidates A1 to A8 illustrated in FIG. 5 are, for example, position data with the axis configurations of the joints J5, J3, J1 being (F, U, T), (F, U, B), (F, D, T), (F, D, B), (N, U, T), (N, U, B), (N, D, T), (N, D, B). “F” represents the wrist being up (Flip), and “N” represents the wrist being down (Noflip). “U” represents the arm being up (Up), and “D” represents the arm being down (Down). “T” represents the arm being forward (FronT), and “B” represents the arm being back (Back).

Note that the axis configuration indicates where the control points of the arms and wrists of the robot 10 are located with respect to the control surface of each of the joints J1, J3, J5. In this case, the number of candidates for the forms (or position data) becomes, for example, more than eight when considering the rotation number, etc. of the joints J4, J5, J6.

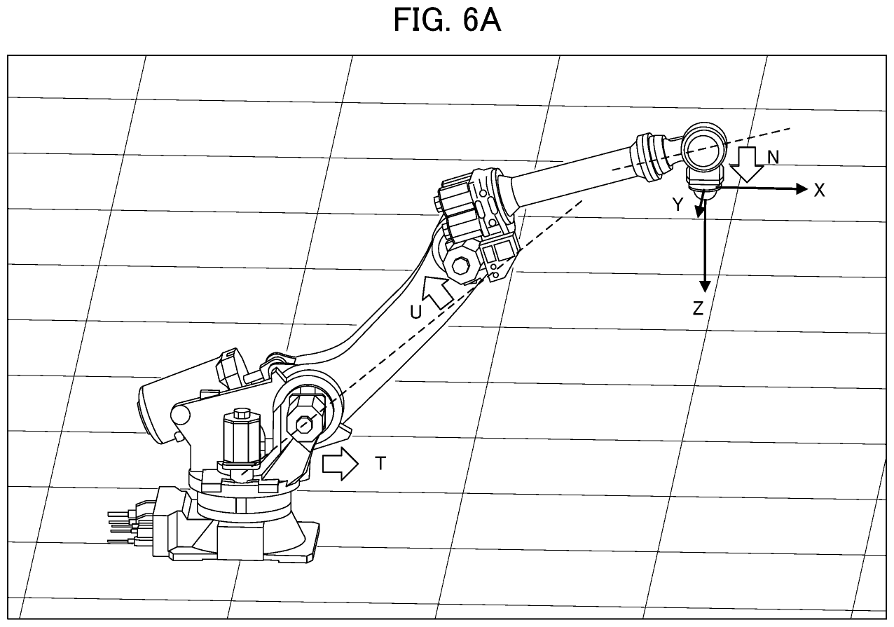

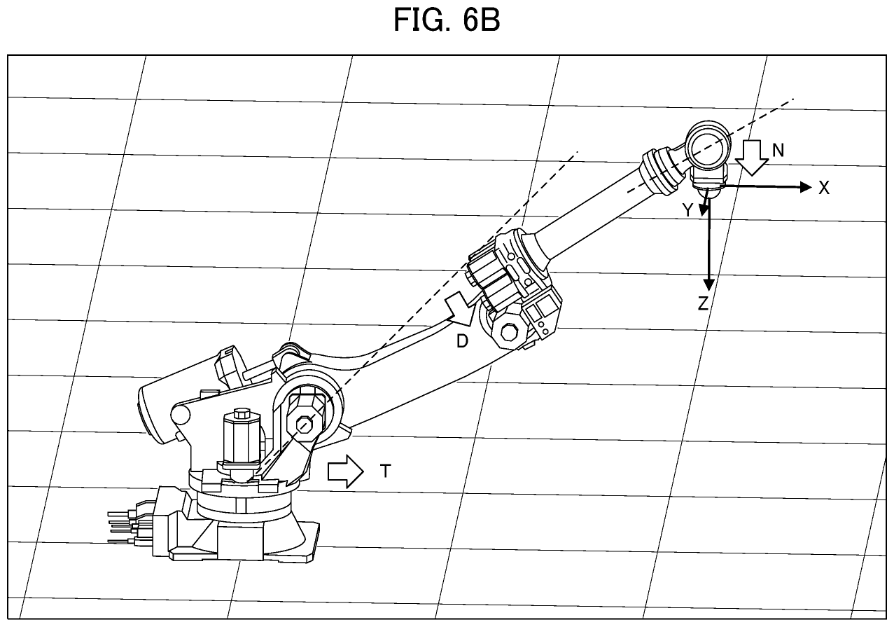

FIGS. 6A and 6B are diagrams illustrating an example of different forms of the robot 10 with the same orthogonal coordinate values. Note that FIG. 6A illustrates the form of the robot 10 when the position data is (N, U, T), and FIG. 6B illustrates the form of the robot 10 when the position data is (N, D, T).

Next, the posture tentative designation unit 311 tentatively designates a plurality of (such as eight) candidates for forms (postures) obtained for each of the plurality of position data by inverse kinematic calculation, and excludes invalid forms that cannot be attained by the robot 10 from the plurality of tentatively designated candidates for forms (postures).

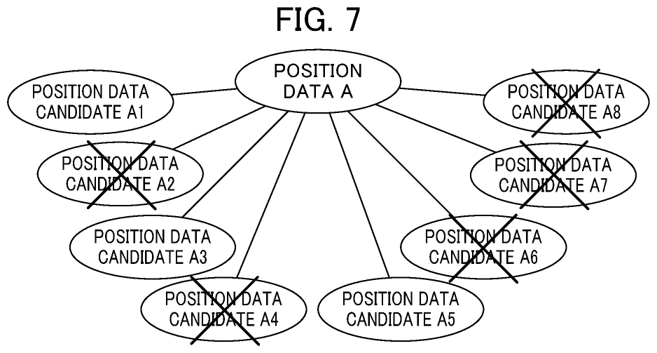

Specifically, the posture tentative designation unit 311 excludes forms that exceed the stroke limit, forms that interfere with obstacles, forms that become a singularity, etc. For example, as illustrated in FIG. 7, the posture tentative designation unit 311 excludes the position data candidates A2, A4, A6 to A8, from among the position data candidates A1 to A8 corresponding to the “position data A” illustrated in FIG. 5.

Note that the position data that exceeds the stroke limit refers to position data that exceeds the stroke limit value, and the posture tentative designation unit 311 may make a judgment through comparison with the stroke limit value specific to the robot 10.

With regard to the position data that interferes with obstacles, the posture tentative designation unit 311 may determine whether the CAD of the robot 10 interferes with other CAD data of peripheral devices and workpieces, etc.

With regard to the position data that becomes a singularity, the posture tentative designation unit 311 may make a judgment by comparing the tentatively designated form with the singularity specific to the robot 10.

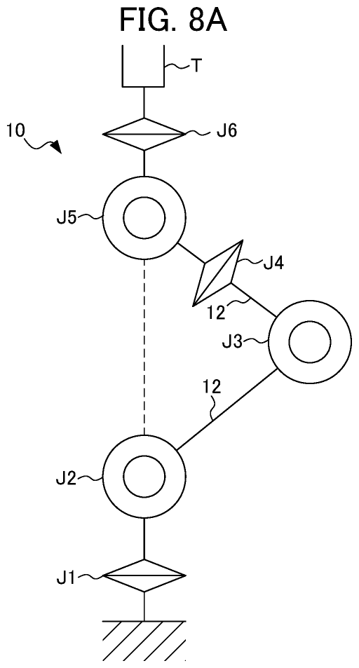

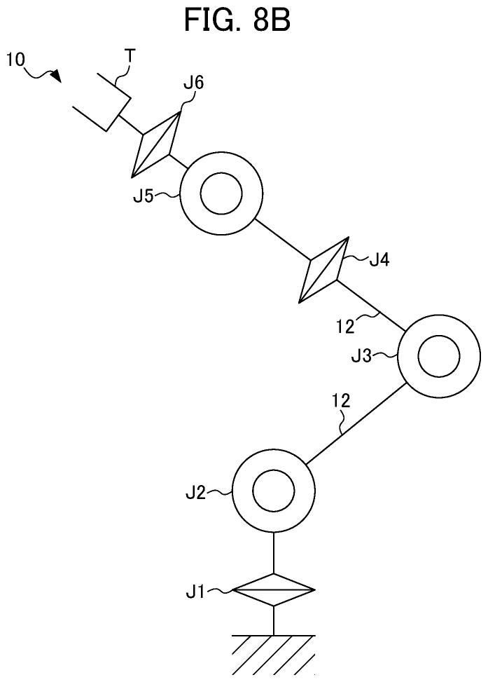

FIGS. 8A and 8B are diagrams illustrating an example of a singularity of the form of the robot 10.

The form (posture) of the robot 10 in FIG. 8A is a singularity when the joint J1 and joint J6 are aligned in a straight line. On the other hand, the form (posture) of the robot 10 in FIG. 8B is a singularity when the joint J4 and joint J6 are aligned in a straight line.

### <Motion Program Generation Unit 312>

The motion program generation unit 312 generates a plurality of motion programs by combining position data candidates for the forms (postures) remaining without being excluded for each of the plurality of position data.

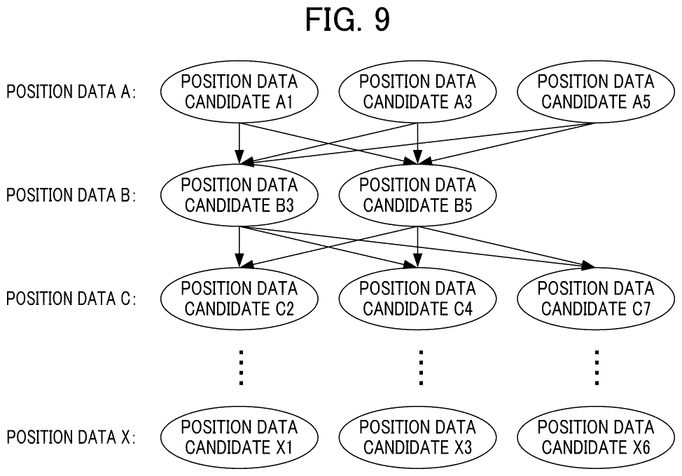

Specifically, as illustrated in FIG. 9, the motion program generation unit 312 generates a plurality of motion programs by combining the remaining candidates for position data (forms) in each of “position data A”, “position data B”, “position data X”, etc., which were not excluded by the posture tentative designation unit 311.

### <Motion Program Selection Unit 313>

The motion program selection unit 313 simulates each of the generated motion programs, calculates the evaluation index value, and selects the motion program with the smallest evaluation index value as the optimal motion program.

Specifically, the motion program selection unit 313 executes simulations for each of the generated motion programs, interpolating as necessary. When the execution of the motion program does not complete in the simulation, the motion program whose execution does not complete would pass through the orthogonal coordinate values that become invalid position data that cannot be attained by the robot 10, i.e., stroke limit, singularity, and interference with obstacles; therefore, the motion program selection unit 313 excludes and deletes the motion program.

Then, the motion program selection unit 313 simulates each of the remaining motion programs to calculate the cycle time of the robot 10 as the evaluation index value. The motion program selection unit 313 selects the motion program with the smallest cycle time as the optimal motion program.

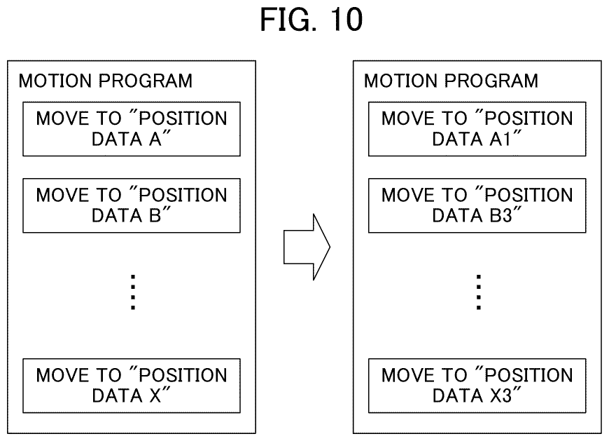

FIG. 10 is a diagram illustrating an example of the motion program before and after the update.

As illustrated in FIG. 10, the motion program selection unit 313 selects, for example, a motion program that combines a position data candidate A1, a position data candidate B3, a position data candidate X3, etc., as the motion program with the smallest cycle time, from among the motion programs generated from the combinations of the position data illustrated in FIG. 9.

The motion program selection unit 313 outputs the selected (optimized) motion program to the robot control device 20. The motion program selection unit 313 may store the selected (optimized) motion program in the storage unit 34.

The motion program selection unit 313 calculates the cycle time of the robot 10 as the evaluation index value; however, this is not limiting. For example, the motion program selection unit 313 may calculate the power consumption of the robot 10 for each motion program by executing simulations of each motion program, and use this as the evaluation index value. The motion program selection unit 313 may select the motion program with the smallest power consumption as the optimal motion program.

### <Optimization Processing by Optimization Assistance Device 30>

Next, the operation related to the optimization processing by the optimization assistance device 30 according to the present embodiment will be described.

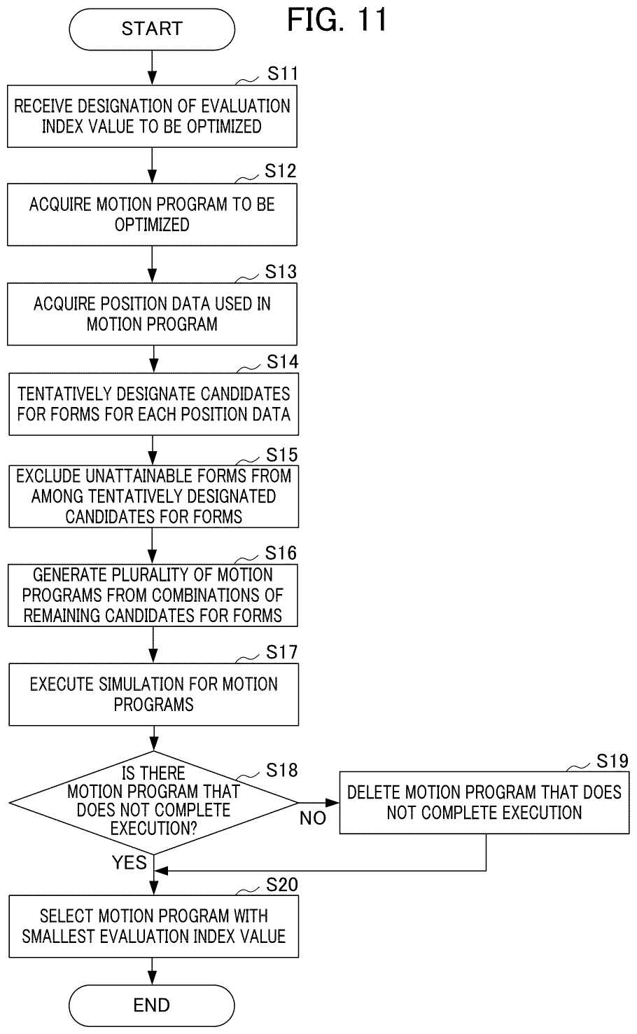

FIG. 11 is a flowchart illustrating the optimization processing by the optimization assistance device 30. This flow is executed each time designation of an evaluation index value which the user wishes to optimize is received from the user.

In Step S11, the input unit 32 receives designation of an evaluation index value, such as the cycle time or power consumption, which the user wishes to optimize.

In Step S12, the position data acquisition unit 310 acquires a motion program to be optimized from the robot control device 20.

In Step S13, the position data acquisition unit 310 acquires a plurality of position data of the coordinate values (x, y, z, w, p, r) in the world coordinate system Σw used in the motion program acquired in Step S12.

In Step S14, the posture tentative designation unit 311 tentatively designates candidates for a plurality of forms (position data) that the robot 10 can take for each position data acquired in Step S13.

In Step S15, the posture tentative designation unit 311 excludes forms (position data) that cannot be attained by the robot 10 from among the plurality of tentatively designated candidates for forms (position data) for each position data in Step S14.

In Step S16, the motion program generation unit 312 generates a plurality of motion programs, from combinations of the remaining candidates for forms (position data).

In Step S17, the motion program selection unit 313 executes simulation for each of the plurality of motion programs generated in Step S16.

In Step S18, the motion program selection unit 313 determines whether there is a motion program that does not complete execution when the simulation of the motion program is executed. If there is a motion program that does not complete execution, the processing proceeds to Step S19. On the other hand, if there are no motion programs that do not complete execution, the processing proceeds to Step S20.

In Step S19, the motion program selection unit 313 excludes and deletes the motion program that does not complete execution.

In Step S20, the motion program selection unit 313 calculates the evaluation index values designated in Step S11 by simulating each motion program for the robot 10, and selects the motion program with the smallest evaluation index value among the calculated evaluation index values, as the optimal motion program. Then, the motion program selection unit 313 outputs the selected (optimized) motion program to the robot control device 20.

As described above, when executing the motion simulation, the optimization assistance device 30 according to one embodiment can easily set the candidates for forms that can be attained by the robot for each designated position data, without changing the arrangement or position coordinates of the robot for a motion program that has already been created and can be executed to the end, and optimize the motion program by performing a motion simulation.

Although the above describes one embodiment, the optimization assistance device 30 is not limited to the embodiment described, and can include variations and improvements that can achieve its objectives.

### Modification Example 1

In one embodiment, the optimization assistance device 30 acquires a motion program that has already been created and can be executed to the end, from the robot control device 20; however, this is not limiting. For example, instead of the motion program, the optimization assistance device 30 may acquire the orthogonal coordinate values (x, y, z, w, p, r) of the position of the tip of the robot 10 in the world coordinate system Σw, which are taught by the user operating the teaching operation panel (not illustrated) of the robot control device 20, from the robot control device 20.

In this manner, the robot control device 20 can acquire an optimized motion program from the optimization assistance device 30 from the beginning.

### Modification Example 2

For example, the embodiment has described an example of eight (=2³) combination candidates of “up and down of the wrist”, “up and down of the arm”, and “front and back of the arm” from the axis configuration of each of the joints J5, J3, J1 for one position data; however, this is not limiting. For example, depending on the configuration of the robot 10, a person skilled in the art may appropriately create candidates other than the example above.

### Modification Example 3

For example, in the embodiment, the optimization assistance device 30 has been described as a device different from the robot control device 20; however, this is not limiting. For example, the optimization assistance device 30 may be included in the robot control device 20.

### Modification Example 4

For example, in the above-described embodiment, the optimization assistance device 30 deletes a motion program that does not complete execution; however, this is not limiting. For example, even with a motion program that does not complete execution, the optimization assistance device 30 can generate an optimal program that can be executed to the end, by replacing invalid position data that cannot be attained by the robot 10 in use, with position data that is operational and has the shortest cycle time or minimal power consumption.

Each function included in the optimization assistance device 30 according to one embodiment can be implemented by hardware, software, or a combination of these. Here, implementation by software refers to implementation by a computer reading and executing a program.

Each component included in the optimization assistance device 30 can be implemented by hardware including electronic circuits, etc., software, or a combination of these.

The program can be stored using various types of non-transitory computer-readable media and can be supplied to a computer. Non-transitory computer-readable media include various types of tangible recording media. Examples of non-transitory computer-readable media include magnetic recording media (such as flexible disks, magnetic tape, hard disk drives), magneto-optical recording media (such as magneto-optical disks), CD-ROM (Read Only Memory), CD-R, CD-R/W, semiconductor memories (such as mask ROM, PROM (Programmable ROM), EPROM (Erasable PROM), flash ROM, RAM). The program may be supplied to the computer by various types of transitory computer-readable media. Examples of transitory computer-readable media include electrical signals, optical signals, and electromagnetic waves. Transitory computer-readable media can supply the program to the computer via wired communication paths such as electrical wires and optical fibers, or via wireless communication paths.

Note that the steps describing the program recorded on the recording medium include not only the processing performed in chronological order, but also processing that may not necessarily be processed chronologically, and processing executed in parallel or individually.

In other words, the optimization assistance device of the present disclosure can take various embodiments with configurations as follows.

(1) The optimization assistance device 30 of the present disclosure is an optimization assistance device that optimizes a motion program of a robot 10 by considering a form of the robot 10, in which the device includes: a position data acquisition unit 310 configured to acquire a plurality of position data of coordinate values in an orthogonal coordinate system taught along a motion path of the robot 10 used in the motion program of the robot 10; a posture tentative designation unit 311 configured to tentatively designate a plurality of forms that can be taken by the robot 10 for each of the plurality of position data, and exclude a form that cannot be attained by the robot 10, from among the plurality of forms tentatively designated; a motion program generation unit 312 configured to generate a plurality of motion programs by combining remaining forms in each of the plurality of position data; and a motion program selection unit 313 configured to simulate each of the plurality of motion programs generated, calculate evaluation index values, and select a motion program with the smallest evaluation index value calculated, as an optimal motion program.

When executing the motion simulation, the optimization assistance device 30 can easily set the candidates for forms that can be attained by the robot for each designated position data, without changing the arrangement or position coordinates of the robot for a motion program that has already been created and can be executed to the end, and optimize the motion program by performing a motion simulation.

(2) In the optimization assistance device 30 described in (1), the evaluation index value may a cycle time of the robot 10.

As a result, the optimization assistance device 30 can generate an optimal motion program with the shortest cycle time.

(3) In the optimization assistance device 30 described in (1), the evaluation index value may be power consumption of the robot 10.

As a result, the optimization assistance device 30 can generate an optimal motion program with the minimum power consumption.

(4) In the optimization assistance device 30 described in any one of (1) to (3), the posture tentative designation unit 311 may exclude a form that includes a stroke limit vicinity, a singularity, or an interference with an obstacle, as a form that cannot be attained by the robot 10.

As a result, the optimization assistance device 30 can pre-exclude forms that cannot be attained by the robot 10, thus can avoid generating unnecessary motion programs and executing simulations of unnecessary motion programs, and can shorten the processing time.

(5) In the optimization assistance device 30 described in any one of (1) to (4), the motion program selection unit 313 may delete a motion program that does not complete execution when simulating each of the plurality of motion programs.

As a result, the optimization assistance device 30 can avoid selecting motion programs that do not complete motion.

### EXPLANATION OF REFERENCE NUMERALS

1: robot system
10: robot
20: robot control device
30: optimization assistance device
31: control unit
310: position data acquisition unit
311: posture tentative designation unit
312: motion program generation unit
313: motion program selection unit

1. An optimization assistance device that optimizes a motion program of a robot by considering a form of the robot, the device comprising:
a position data acquisition unit configured to acquire a plurality of position data of coordinate values in an orthogonal coordinate system taught along a motion path of the robot used in the motion program of the robot;
a posture tentative designation unit configured to tentatively designate a plurality of forms that can be taken by the robot for each of the plurality of position data, and exclude a form that cannot be attained by the robot, from among the plurality of forms tentatively designated;
a motion program generation unit configured to generate a plurality of motion programs by combining remaining ones of the forms in each of the plurality of position data; and
a motion program selection unit configured to simulate each of the plurality of motion programs generated, calculate evaluation index values, and select a motion program with the smallest evaluation index value calculated, as an optimal motion program.

2. The optimization assistance device according to claim 1, wherein
the evaluation index value is a cycle time of the robot.

3. The optimization assistance device according to claim 1, wherein
the evaluation index value is power consumption of the robot.

4. The optimization assistance device according to claim 1, wherein
the posture tentative designation unit excludes a form that includes a stroke limit vicinity, a singularity, or an interference with an obstacle, as a form that cannot be attained by the robot.

5. The optimization assistance device according to claim 1, wherein
the motion program selection unit deletes a motion program that does not complete execution when simulating each of the plurality of motion programs.
